(19) United States
(12) Patent Application Publication
(10) Pub. No.: US 2014/0139469 A1
(43) Pub. Date: May 22, 2014

(54) TOUCH PANEL DEVICE AND CONTROL METHOD OF TOUCH PANEL DEVICE

(71) Applicant: PANASONIC LIQUID CRYSTAL DISPLAY CO., LTD,, Hyogo (JP)

(72) Inventor: Satoshi HIROTSUNE, Hyogo (JP)

(73) Assignee: PANASONIC LIQUID CRYSTAL DISPLAY CO., LTD,, Hyogo (JP)

(21) Appl. No.: 14/086,943

(22) Filed: Nov. 21, 2013

(30) Foreign Application Priority Data
Nov. 21, 2012 (JP) 2012-255379

(51) Int. Cl. G06F 3/041

(52) U.S. Cl. CPC G06F 3/041
USPC 345/173

(57) ABSTRACT

A touch panel device includes first and second electrode pairs each of which is provided on a substrate so as to form a capacitor, a first wire connected to one electrode of the first electrode pair, a second wire connected to one electrode of the second electrode pair, a voltage applying portion connected to the first and second wires and respectively applying first and second voltages to the first and second wires, a detector respectively detecting, as first and second detection voltages, voltages of the first and second electrode pairs respectively generated by applying the first and second voltages from the voltage applying portion, and a processor performing predetermined processing in response to the first and second detection voltages detected by the detector. The first wire is longer than the second wire. The voltage applying portion sets the first voltage higher than the second voltage.

### CROSS-REFERENCE TO RELATED APPLICATIONS

This application claims the benefit of priority to Japanese Patent application No. 2012-255379 filed on Nov. 21, 2012, the entire content of which is hereby incorporated herein by reference.

### TECHNICAL FIELD

The present disclosure relates to a touch panel device of an electrostatic capacity type and a control method of the touch panel device.

### BACKGROUND

Electrode pairs are provided on a substrate in a touch panel device of an electrostatic capacity type. In the touch panel device, when a voltage is applied on one electrode of an electrode pair, a voltage generated at the other electrode of the electrode pair is detected. The detected voltage changes in response to a change in capacitance of an electrode pair caused by presence or absence of a contact of a finger. The presence or absence of the contact of a finger is detected based on the change in the detected voltage. Then, processing of calculating coordinates of a contact position or the like is performed.

In such a touch panel device, generally, a connecting terminal for connecting to an external circuit is provided at a periphery on the substrate. The respective electrodes of the electrode pairs and the connecting terminals are connected respectively by wires. Consequently, a length of each of the wires from the electrode pairs to the connecting terminals differs from each other depending on positions of the electrode pairs on the substrate. As a result, capacitance of the electrode pairs differs by the positions of the electrode pairs. Consequently, voltages generated at the electrodes differ from each other. As a result, the detected voltage varies if the difference is as it is. Hence, according to a touch panel device described in Japanese Patent Application Laid-open No. 2009-258935 for example, when a wire length is prolonged, a wire width is enlarged. Thereby, according to the touch panel device described in Japanese Patent Application Laid-open No. 2009-258935, a variation in a detected voltage is reduced by reducing difference in capacitance of each of the electrode pairs owing to difference in each of wire lengths.

However, although the wire width is changed in the touch panel device described in Japanese Patent Application Laid-open No. 2009-258935, detection processing of the touch panel needs to be carried out in accordance with a time constant of a wire having the longest wire length. Consequently, a long period of time is required for detection.

### SUMMARY

It is an object of the present disclosure to provide a touch panel device and a control method of the touch panel device which may reduce a degree of prolongation of a detection time period even in a case where a wire length is long.

In one general aspect, the instant application describes a touch panel device including a first electrode pair and a second electrode pair each of which is provided on a substrate so as to form a capacitor; a first wire which is connected to one electrode of the first electrode pair; a second wire which is connected to one electrode of the second electrode pair; a voltage applying portion which is connected to the first wire to apply a first voltage to the first wire and is connected to the second wire to apply a second voltage to the second wire; a detector which detects a voltage of the first electrode pair as a first detection voltage and a voltage of the second electrode pair as a second detection voltage, the first detection voltage being generated by applying the first voltage from the voltage applying portion, the second detection voltage being generated by applying the second voltage from the voltage applying portion; and a processor which performs predetermined processing in response to the first and second detection voltages detected by the detector, wherein the first wire is configured to be longer than the second wire, and the voltage applying portion sets the first voltage higher than the second voltage.

A control method of the touch panel described above, the control method including the steps of: applying a first voltage to the first wire and a second voltage to the second wire by the voltage applying portion; detecting a voltage generated at the first electrode pair as a first detection voltage and a voltage generated at the second electrode pair as a second detection voltage by the detector; and performing predetermined processing in response to the first and second detection voltages by the processor, wherein the first voltage is set to be higher than the second voltage.

According to the disclosure, a degree of prolongation of a detection time period, produced by resistance difference owing to difference between a length of the first wire and a length of the second wire, may be reduced.

### BRIEF DESCRIPTION OF THE DRAWINGS

FIG. 1 is a block diagram showing a configuration of a touch panel device according to an embodiment of the present application;

FIG. 2 is a view schematically showing a panel portion shown in FIG. 1;

FIG. 3 is a sectional view taken along a line A-A of FIG. 2;

FIG. 4 illustrates timing charts describing voltage values respectively applied from buffers to wires;

FIG. 5 illustrates timing charts describing a timing at which a voltage detecting circuit detects a voltage; and

FIG. 6 illustrates timing charts describing a timing at which the voltage detecting circuit detects a voltage.

### DETAILED DESCRIPTION

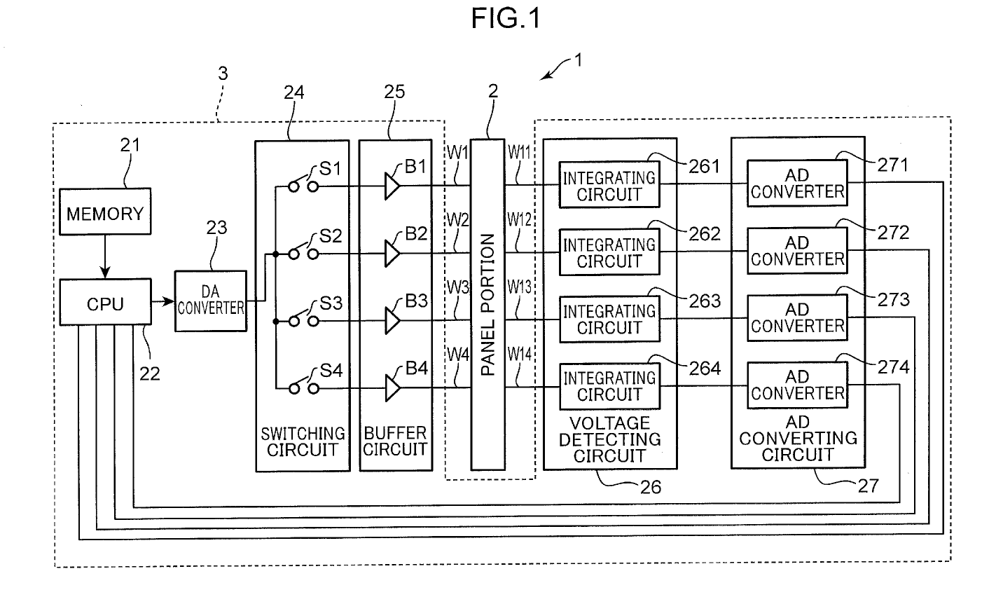

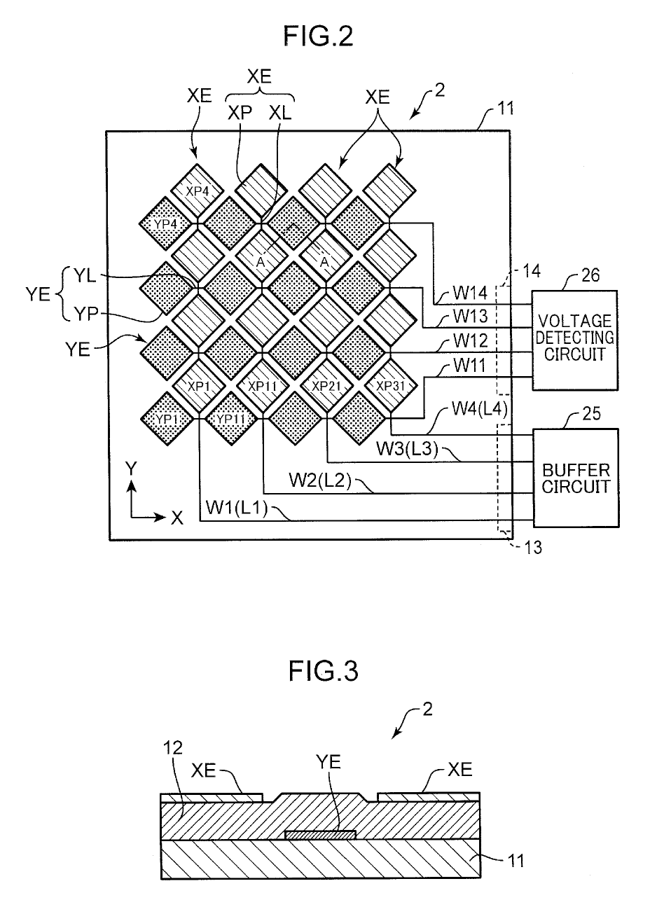

FIG. 1 is a block diagram showing a configuration of a touch panel device according to an embodiment of the present application. FIG. 2 is a view schematically showing a panel portion shown in FIG. 1. FIG. 3 is a sectional view taken along a line A-A of FIG. 2. As shown in FIG. 1, a touch panel device 1 includes a panel portion 2 and a controller 3.

The panel portion 2 includes a transparent substrate 11, a Y electrode YE, an insulating film 12, and an X electrode XE as shown in FIG. 2 and FIG. 3. The transparent substrate 11 is made of, for example, glass. The Y electrode YE is provided on a surface of the substrate 11. The insulating film 12 is provided to cover the Y electrode YE. The X electrode XE is provided on the insulating film 12. The controller 3 includes a memory 21, a central processing unit (CPU) 22, a digital-analog (DA) converter 23, a switching circuit 24, a buffer circuit 25, a voltage detecting circuit 26, and an analog-digital (AD) converting circuit 27 as shown in FIG. 1.

As shown in FIG. 2, the Y electrodes YE extend in X direction, and are arranged side by side in Y direction (for example, 4 pieces thereof in FIG. 2). The Y electrode YE is formed by a transparent conductive film made of, for example, indium tin oxide (ITO). The Y electrode YE includes a wide pad portion YP and a narrow linear portion YL. The pad portions YP and the liner portions YL are formed alternately aligning in X direction. 4 pieces of the Y electrodes YE are provided such that the pad portions YP and the linear portions YL are respectively disposed at the same positions in X direction. The pad portion YP is formed in, for example, a rhombic shape, and is connected to the linear portions YL at a pair of respective diagonal corners of the rhombic shape.

The X electrodes XE extend in Y direction, and are arranged side by side in X direction (for example, 4 pieces thereof in FIG. 2). The X electrode XE is also formed by a transparent conductive film made of, for example, ITO. The X electrode XE includes a wide pad portion XP formed and a narrow linear portion XL. The pad portions XP and the linear portions XL are formed alternately aligning in Y direction. 4 pieces of the X electrodes XE are provided such that the pad portions XP and the linear portions XL are respectively disposed at the same positions in Y direction. The pad portion XP is formed in, for example, a rhombic shape, and is connected to the linear portions XL at a pair of respective diagonal corners of the rhombic shape.

The X electrode XE and the Y electrode YE are provided such that the X electrode XE and the Y electrode YE intersect each other at the linear portion XL and the linear portion YL thereof, and the pad portion XP and the pad portion YP thereof do not overlap each other. That is, the Y electrodes YE surround the pad portion XP of the X electrode XE by 4 pieces of the pad portions YP contiguous to each other. There are clearances between the pad portion XP of the X electrode XE and 4 pieces of the pad portions YP of the Y electrodes YE surrounding the pad portion XP. Thereby, the pad portions XP of the X electrodes XE and the pad portions YP of the Y electrodes YE are arranged in zigzag on the substrate 11. The electrode pair configured by the X electrode XE and the corresponding Y electrode YE arranged in this way forms a capacitor.

The X electrodes XE are respectively connected to wires W1 to W4 at lower end portions in FIG. 2, for example. The respective wires W1 to W4 are connected to the buffer circuit 25 via a connecting terminal 13 provided at an end portion of the substrate 11. The Y electrodes YE are respectively connected to wires W11 to W14 at right end portions in FIG. 2, for example. The respective wires W11 to W14 are connected to the voltage detecting circuit 26 via a connecting terminal 14 provided at an end portion of the substrate 11.

Here, with regard to a relationship in length among a wire length L1 of the wire W1, a wire length L2 of the wire W2, a wire length L3 of the wire W3, and a wire length L4 of the wire W4, L1>L2>L3>L4 is established as is known from FIG. 2. The respective wires W1 to W4 are formed by transparent conductive films made of, for example, indium tin oxide (ITO). Thereby, the respective wires may be fabricated by a process the same as that of the Y electrode YE or the X electrode XE, and a fabrication thereof is facilitated.

However, the respective wires W1 to W4 may be copper wires. A resistance of the copper wire is lower than that of indium tin oxide (ITO), and therefore, an influence of difference in resistance owing to difference in a length of the wire may further be reduced. Note that wire widths of the wires W1 to W4 are made to be the same.

In FIG. 1, the memory 21 is configured by a nonvolatile memory such as a flash memory. The memory 21 holds programs for the CPU 22. The memory 21 holds voltage values (described later) of voltages respectively applied to the wires W1 to W4. The CPU 22 operates in accordance with the program held by the memory 21. The CPU 22 outputs control signals to the DA converter 23 in turn so as to respectively apply voltages of the voltage values held by the memory 21 to the wires W1 to W4. The DA converter 23 outputs voltage signals of analog values in turn to buffers B1 to B4 of the buffer circuit 25 via the switching circuit 24 in accordance with the control signals of digital values output from the CPU 22.

The switching circuit 24 includes switches S1 to S4, each of which is configured by, for example, a field effect transistor (FET). The switching circuit 24 switches connections between the DA converter 23 and the buffers B1 to B4 of the buffer circuit 25 in turn.

First, the switching circuit 24 turns the switch S1 on to connect the DA converter 23 and the buffer B1, and turns the switches S2 to S4 off to interrupt connections between the DA converter 23 and the buffers B2 to B4. The buffer B1 outputs a voltage value based on voltage signals from the DA converter 23 to the wire W1 under this state.

Successively, the switching circuit 24 turns the switch S2 on to connect the DA converter 23 and the buffer B2, and turns the switches S1, S3, and S4 off to interrupt connections between the DA converter 23 and the buffers B1, B3, and B4. The buffer B2 outputs a voltage value based on voltage signals from the DA converter 23 to the wire W2 under this state.

Successively, the switching circuit 24 turns the switch S3 on to connect the DA converter 23 and the buffer B3, and turns the switches S1, S2, and S4 off to interrupt connections between the DA converter 23 and the buffers B1, B2, and B4. The buffer B3 outputs a voltage value based on voltage signals from the DA converter 23 to the wire W3 under this state.

Further, the switching circuit 24 turns the switch S4 on to connect the DA converter 23 and the buffer B4, and turns the switches S1 to S3 off to interrupt connections between the DA converter 23 and the buffers B1 to B3. The buffer B4 outputs a voltage value based on voltage signals from the DA converter 23 to the wire W4 under this state. In this way, the voltages are applied from the buffers B1 to B4 to the wires W1 to W4 in turn.

The voltage detecting circuit 26 includes integrating circuits 261 to 264 respectively connected to the wires W11 to W14. The integrating circuits 261 to 264 detect voltages (voltages of Y electrodes YE in the present embodiment) generated at the electrode pairs (capacitors) configured by the X electrodes XE and the corresponding Y electrodes YE as detected voltages, the voltages being generated by applying voltages from the buffers B1 to B4 to the X electrodes XE respectively.

Each of the integrating circuits 261 to 264 includes, for example, an operational amplifier, a capacitor, and the like. The integrating circuits 261 to 264 respectively reset the voltages of the Y electrodes YE after detecting or simultaneously with detecting the voltages of the Y electrodes YE. The integrating circuits 261 to 264 respectively output voltage signals corresponding to the detected voltages to the AD converting circuit 27.

The AD converting circuit 27 includes AD converters 271 to 274 respectively connected to the integrating circuits 261 to 264. The AD converters 271 to 274 convert the voltage signals output from the integrating circuits 261 to 264 respectively to digital values of a predetermined bit number (for example, 8 bits). The AD converters 271 to 274 output the voltage signals of the digital values to the CPU 22.

The CPU 22 detects presence or absence of a contact of a finger to the panel portion 2 based on the voltage signals of the digital values output from the AD converters 271 to 274. The CPU 22 performs predetermined processing such as calculating X coordinate and Y coordinate of a contact position of the finger in contact with the panel portion 2. In the present embodiment, the buffer circuit 25 corresponds to an example of the voltage applying portion, the voltage detecting circuit 26 corresponds to an example of the detector, the CPU 22 corresponds to an example of the processor, and the memory 21 corresponds to an example of the storage.

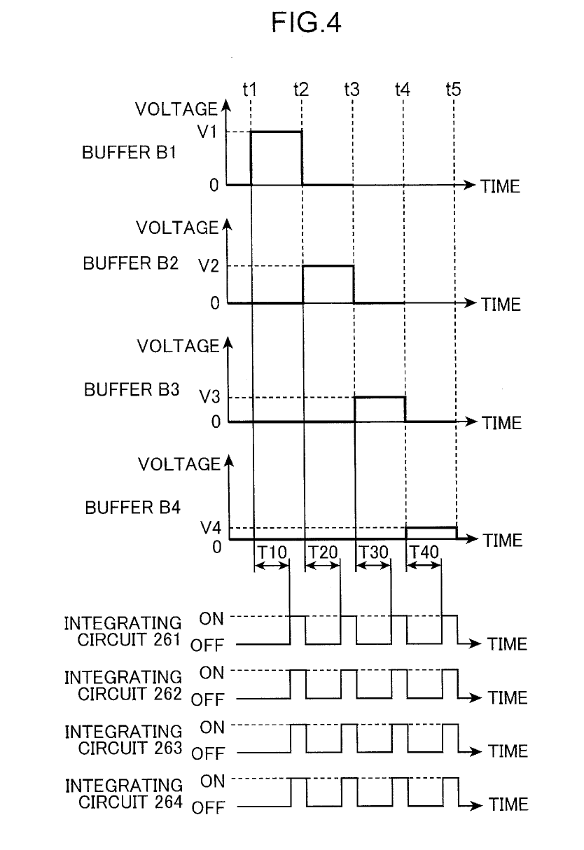

FIG. 4 illustrates timing charts describing voltage values respectively applied from the buffers B1 to B4 to the wires W1 to W4. In FIG. 4, a voltage of a voltage value V1 is applied from the buffer B1 to the X electrode XE via the wire W1 from time t1 to time t2. Then, voltages generated at the corresponding Y electrodes YE are detected by the integrating circuits 261 to 264 of the voltage detecting circuit 26 via the wires W11 to W14 after a time period T10 has elapsed from time t1.

For example, a voltage, which is generated at a pad portion YP1 of the Y electrode YE corresponding to a pad portion XP1 at the lowermost end in FIG. 2 by applying a voltage to the X electrode XE via the wire W1, is detected by the integrating circuit 261 via the wire W11. Further, for example, a voltage, which is generated at a pad portion YP4 of the Y electrode YE corresponding to a pad portion XP4 of the uppermost end in FIG. 2 by applying a voltage to the X electrode XE via the wire W1, is detected by the integrating circuit 264 via the wire W14.

Similarly, a voltage of a voltage value V2 is applied from the buffer B2 to the X electrode XE via the wire W2 from time t2 to time t3. Then, voltages generated at the corresponding Y electrodes YE are detected by the integrating circuits 261 to 264 of the voltage detecting circuit 26 via the wires W11 to W14 after a time period T20 has elapsed from time t2. For example, a voltage, which is generated at a pad portion YP11 of the Y electrode YE corresponding to a pad portion XP11 at the lowermost end in FIG. 2 by applying a voltage to the X electrode XE via the wire W2, is detected by the integrating circuit 261 via the wire W11.

Further, a voltage of a voltage value V3 is applied from the buffer B3 to the X electrode XE via the wire W3 from time t3 to time t4. Then, voltages generated at the corresponding Y electrodes YE are detected by the integrating circuits 261 to 264 of the voltage detecting circuit 26 via the wires W11 to W14 after a time period T30 has elapsed from time t3. For example, a voltage, which is generated at a pad portion YP21 of the Y electrode YE corresponding to a pad portion XP21 at the lowermost end in FIG. 2 by applying a voltage to the X electrode XE via the wire W3, is detected by the integrating circuit 261 via the wire W11.

Furthermore, a voltage of a voltage value V4 is applied from the buffer B4 to the X electrode XE via the wire W4 from time t4 to time t5. Then, voltages generated at the corresponding Y electrodes YE are detected by the integrating circuits 261 to 264 of the voltage detecting circuit 26 via the wires W11 to W14 after a time period T40 has elapsed from time t4. For example, a voltage, which is generated at a pad portion YP31 of the Y electrode YE corresponding to a pad portion XP31 at the lowermost end in FIG. 2 by applying a voltage to the X electrode XE via the wire W4, is detected by the integrating circuit 261 via the wire W11.

As described above, the relationship in length of the wire lengths L1 to L4 of the wires W1 to W4 is established as L1>L2>L3>L4. In the present embodiment, the voltage values V1 to V4 respectively applied from the buffers B1 to B4 to the wires W1 to W4 are set to be voltage values satisfying L1/L2/L3/L4=V1/V2/V3/V4. The memory 21 holds the voltage values V1 to V4 satisfying L1/L2/L3/L4=V1/V2/V3/V4. The CPU 22 outputs control signals representing the voltage values V1 to V4 held in the memory 21 to the DA converter 23.

Note that, the memory 21 may hold the voltage values V1 to V4 satisfying, for example, L1/L2/L3/L4≅V1/V2/V3/V4 without being limited to the voltage values V1 to V4 satisfying L1/L2/L3/L4≅V1/V2/V3/V4. Further, the memory 21 may hold the voltage values V1 to V4 which satisfy a relationship that V1/V2/V3/V4 is proportional to L1/L2/L3/L4, for example. Furthermore, the memory 21 may hold the voltage values V1 to V4 which are proportional to, for example, the wire lengths L1 to L4.

The longer the wire length, the larger the RC time constant due to increase of a resistance component. Consequently, when a voltage of the same value is applied to each of the X electrodes XE, the longer the wire length, the more gradual the degree of increase of a voltage generated at each of the Y electrodes YE. Hence, in the present embodiment, the voltage values V1 to V4 are made proportional to the wire lengths L1 to L4. Thereby, in the present embodiment, a degree of prolongation of a detection time period caused by resistance difference owing to difference in the wire length may be reduced.

In the present embodiment, the wire length is defined as a length of the wire W1 from the buffer circuit 25 to the most proximate pad portion XP of the X electrode XE. That is, the wire length L1 is a length of the wire W1 from the buffer B1 to the pad portion XP1. The wire length L2 is a length of the wire W2 from the buffer B2 to the pad portion XP11. The wire length L3 is a length of the wire W3 from the buffer B3 to the pad portion XP21. The wire length L4 is a length of the wire W4 from the buffer B4 to the pad portion XP31.

Note that a wire length is not limited to the wire length described above. For example, the wire length may be defined as a length of a wire length from the buffer circuit 25 to the remotest pad portion XP of the X electrode XE. That is, for example, the wire length L1 may be defined as a length including the wire W1 from the buffer B1 to the pad portion XP4, the pad portion XP, and the linear portion XL.

For example, the wire length may be defined as an average value of the length of the wire length from the buffer circuit 25 to the most proximate pad portion XP of the X electrode XE and the length of the wire length from the buffer circuit 25 to the remotest pad portion XP of the X electrode XE. That is, for example, the wire length L1 may be defined as an average value of the length of the wire W1 from the buffer B1 to the pad portion XP1, and the length including the wire W1 from the buffer B1 to the pad portion XP4, the pad portion XP, and the linear portion XL.

A length from the buffer circuit 25 to the connecting terminal 13 stays substantially the same in the respective wires. Consequently, the wire length may be defined as a length of the wire length from the connecting terminal 13 to the pad portion XP. Further, the wire length may be defined as an average value of a length of the wire length from the connecting terminal 13 to the most proximate pad portion XP, and a length of the wire length from the connecting terminal 13 to the remotest pad portion XP. In the present embodiment, the pad portion XP1 and the pad portion YP1 correspond to an example of the first electrode pair, and the pad portion XP11 and the pad portion YP11 correspond to an example of the second electrode pair. Further, in the present embodiment, the wire W1 corresponds to an example of the first wire, and the wire W2 corresponds to an example of the second wire. Furthermore, in the present embodiment, the voltage generated at the pad portion YP1 corresponds to an example of the first detection voltage and the voltage generated at the pad portion YP11 corresponds to an example of the second detection voltage. Still further, in the present embodiment, the voltage value V1 corresponds to an example of the first voltage, and the voltage value V2 corresponds to an example of the second voltage.

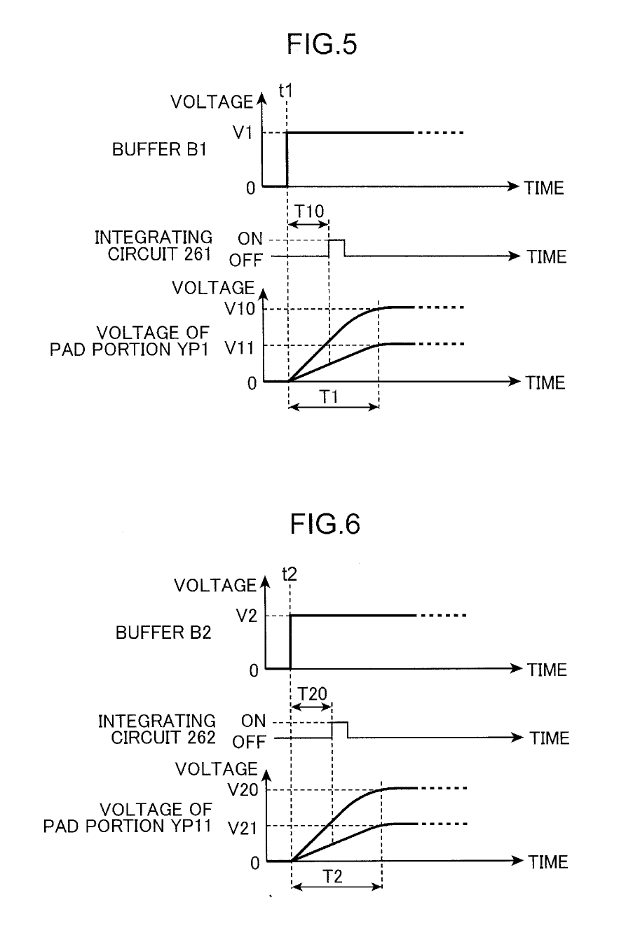

FIG. 5 and FIG. 6 are timing charts describing timings at which the voltage detecting circuit 26 detects a voltage. FIG. 5 shows a timing at which the integrating circuit 261 of the voltage detecting circuit 26 detects a voltage when the buffer B1 applies a voltage of a voltage value V1. FIG. 6 shows a timing at which the integrating circuit 262 of the voltage detecting circuit 26 detects a voltage when the buffer B2 applies a voltage of a voltage value V2. In FIG. 5 and FIG. 6, an element the same as that in FIG. 4 is denoted at the same reference symbol.

In FIG. 5, at time t1, the buffer B1 starts to apply a voltage of the voltage value V1 to the X electrode XE via the wire W1. Then, a voltage generated at the pad portion YP (for example, pad portion YP1 of FIG. 2) of the corresponding Y electrode YE increases from time t1. Here, if the voltage is continued to be applied from the buffer B1, the voltage of the pad portion YP1 continues to increase even after a time point at which the time period T10 has elapsed and at which the voltage is detected by the integrating circuit 261 of the voltage detecting circuit 26. The voltage is asymptotically approximate to a voltage value V10 when the finger is not in contact with the panel portion 2, whereas the voltage is asymptotically approximate to a voltage value V11 (<V10) when the finger is in contact with the panel portion 2, and then a time period T1 elapses.

Here, the time period T1 is a time period from time t1 at which the buffer B1 starts to apply the voltage to a time point at which a digital value thereof remains unchanged when the voltage of the pad portion YP1 is converted to the digital value by the AD converter 271 of the AD converting circuit 27, even though the voltage of the pad portion YP1 increases. In the present embodiment, the time period T10 is set as T10=T1/2.

In FIG. 6, at time t2, the buffer B2 starts to apply a voltage of the voltage value V2 to the X electrode XE via the wire W2. Then, a voltage generated at the pad portion YP (for example, pad portion YP11 of FIG. 2) of the corresponding Y electrode YE increases from time t2. Here, if the voltage is continued to be applied from the buffer B2, the voltage of the pad portion YP11 continues to increase even after a time point at which the time period T20 has elapsed and at which the voltage is detected by the integrating circuit 262 of the voltage detecting circuit 26. The voltage is asymptotically approximate to the voltage value V20 when the finger is not in contact with the panel portion 2, whereas the voltage is asymptotically approximate to a voltage value V21 (<V20) when the finger is in contact with the panel portion 2, and then a time period T2 elapses.

Here, the time period T2 is a time period from time t2 at which the buffer B2 starts to apply the voltage to a time point at which a digital value thereof remains unchanged when the voltage of the pad portion YP11 is converted to the digital value by the AD converter 272 of the AD converting circuit 27, even though the voltage of the pad portion YP11 increases. In the present embodiment, the time period T20 is set as T20=T2/2.

The time periods T30 and T40 are also similarly set. Here, in the present embodiment, bit numbers of the AD converters 271 to 274 stay the same, and therefore, T1=T2, and T10=T20=T30=T40. Note that the time period T10 may be set as T10≦T1/2, and the time period T20 may be set as T20≦T2/2 without being limited to the description described above. In the present embodiment, T10 and T20 correspond to examples of the predetermined time period.

As described above, in the present embodiment, the wire W1 is longer than the wire W2, for example. Consequently, there is resistance difference between the electrode pair connected to the wire W1 and the electrode pair connected to the wire W2. Therefore, in a case where the same voltage is applied to the X electrode XE (for example, pad portion XP1) at the leftmost end in FIG. 2, and the X electrode XE (for example, pad portion XP11) second from the left in FIG. 2, a degree of increase of the voltage generated at the pad portion YP1 is more gradual than a degree of increase of the voltage generated at the pad portion YP11. However, in the present embodiment, the voltage value V1 applied to the pad portion XP1 is higher than the voltage value V2 applied to the pad portion XP11. Consequently, the voltage generated at the pad portion YP1 may be made approximate to the voltage generated at the pad portion YP11 at an early time point. As a result, the voltage detecting circuit 26 may detect the detected voltage at an early time point.

In the present embodiment, the time period T10 is set as T10=T1/2. The integrating circuit 261 of the voltage detecting circuit 26 detects the voltage when the time period T10 has elapsed from time t1 at which the buffer B1 starts to apply the voltage. Here, the time period T1 is a time period from time t1 at which the buffer B1 starts to apply the voltage to a time point at which the digital value remains unchanged when the voltage of the pad portion YP1 is converted to the digital value by the AD converter 271 of the AD converting circuit 27, even though the voltage of the pad portion YP1 increases. Consequently, the voltage is detected by the integrating circuit 261 at a time point at which a half of a time period has elapsed, the time period being an elapsed time until the increase of the voltage is substantially saturated. As a result, the CPU 22 may start processing of calculating a contact position of the finger or the like in response to the detected voltage at a time point earlier than a case where the CPU 22 waits until the voltage is substantially saturated. As the number of aligning the X electrodes XE and the Y electrodes YE on the substrate 11 increases, the effect becomes more significant.

Further, in the present embodiment, wire width of each of the wires W1 to W4 are made to be the same. Consequently, a design of a wiring pattern on the substrate 11 may be performed more easily than in a case where the wire width of each of the wires W1 to W4 is changed.

Note that, in the above embodiment, 4 rows of the X electrodes XE are aligned, and each row of the X electrodes XE includes 4 pieces of the pad portions XP, and 4 rows of the Y electrode YE are aligned, and each row of the Y electrodes YE includes 4 pieces of the pad portions YP. However, this is an example and the number of rows and the number of pieces are not limited thereto.

Note that the specific embodiments described above mainly include embodiments having the following configurations.

In one general aspect, the instant application describes a touch panel device including a first electrode pair and a second electrode pair each of which is provided on a substrate so as to form a capacitor; a first wire which is connected to one electrode of the first electrode pair; a second wire which is connected to one electrode of the second electrode pair; a voltage applying portion which is connected to the first wire to apply a first voltage to the first wire and is connected to the second wire to apply a second voltage to the second wire; a detector which detects a voltage of the first electrode pair as a first detection voltage and a voltage of the second electrode pair as a second detection voltage, the first detection voltage being generated by applying the first voltage from the voltage applying portion, the second detection voltage being generated by applying the second voltage from the voltage applying portion; and a processor which performs predetermined processing in response to the first and second detection voltages detected by the detector, wherein the first wire is configured to be longer than the second wire, and the voltage applying portion sets the first voltage higher than the second voltage.

According to this configuration, each of the first electrode pair and the second electrode pair is provided on the substrate so as to form the capacitor. The first wire is connected to one electrode of the first electrode pair. The second wire is connected to one electrode of the second electrode pair. The first voltage is applied to the first wire by the voltage applying portion connected to the first wire. The second voltage is applied to the second wire by the voltage applying portion connected to the second wire. The voltage generated at the first electrode pair by applying the first voltage from the voltage applying portion is detected as the first detection voltage by the detector. The voltage generated at the second electrode pair by applying the second voltage from the voltage applying portion is detected as the second detection voltage by the detector. The predetermined processing is performed by the processor in response to the first and second detection voltages detected by the detector.

The first wire is longer than the second wire. Consequently, resistance difference is generated between the first electrode pair and the second electrode pair. Accordingly, in a case of applying the same voltage to the first electrode pair and the second electrode pair, a degree of increase of the voltage generated at the first electrode pair becomes more gradual than a degree of increase of the voltage generated at the second electrode pair. However, in this configuration, the first voltage is set to be higher than the second voltage by the voltage applying portion. Therefore, the voltage generated at the first electrode pair may be made more approximate to the voltage generated at the second electrode pair at an early time point. As a result, a degree of prolongation of a detection time period, produced by resistance difference owing to difference between a length of the first wire and a length of the second wire, may be reduced.

The above general aspect may include one or more of the following features. A length of the first wire is defined as L1, a length of the second wire is defined as L2, a voltage value of the first voltage is defined as V1, a voltage value of the second voltage is defined as V2, and the voltage applying portion applies a voltage of the voltage value V1 to the first wire and a voltage of the voltage value V2 to the second wire, the voltage values V1 and V2 satisfying a relationship where V1/V2 is proportional to L1/L2.

According to this configuration, the length of the first wire is defined as L1, the length of the second wire is defined as L2, the voltage value of the first voltage is defined as V1, and the voltage value of the second voltage is defined as V2. The voltage of the voltage value V1 is applied to the first wire and the voltage of the voltage value V2 is applied to the second wire by the voltage applying portion. The voltage values V1 and V2 satisfy a relationship where V1/V2 is proportional to L1/L2. Consequently, the degree of prolongation of the detection time period caused by the resistance difference owing to the difference between the length of the first wire and the length of the second wire may preferably be reduced.

The touch panel device may further comprise a storage which stores the voltage values V1 and V2 which satisfy the relationship where V1/V2 is proportional to L1/L2, wherein the voltage applying portion respectively applies voltages of the voltage values V1 and V2 stored in the storage to the first wire and to the second wire.

According to this configuration, the voltage values V1 and V2 which satisfy the relationship where V1/V2 is proportional to L1/L2 are stored in the storage. Voltages of the voltage values V1 and V2 stored in the storage are respectively applied to the first wire and the second wire by the voltage applying portion. Consequently, voltage values are stored in the storage, and therefore, the degree of prolongation of the detection time period caused by the resistance difference owing to the difference between the length of the first wire and the length of the second wire may easily be reduced.

The detector detects the first detection voltage in a predetermined time period after the first voltage is applied to the first wire by the voltage applying portion, and detects the second detection voltage in the predetermined time period after the second voltage is applied to the second wire by the voltage applying portion.

According to this configuration, the first detection voltage is detected by the detector in the predetermined time period after the first voltage is applied to the first wire by the voltage applying portion. The second detection voltage is detected by the detector in the predetermined time period after the second voltage is applied to the second wire by the voltage applying portion. Therefore, the first and second detection voltages are detected the same predetermined time period after application of the voltages. Consequently, the processor may preferably perform the predetermined processing in response to the first detection voltage and the second detection voltage.

The touch panel device may further comprise an analog-digital converter which converts an analog value to a digital value of a predetermined bit number, wherein the analog-digital converter converts the first detection voltage to the digital value, the first detection voltage increased by the first voltage which is applied to the first wire from the voltage applying portion, a time period, from the time when the voltage applying portion starts to apply the first voltage to the time when the digital value remains unchanged even though the first detection voltage increases, is defined as T1 , and the predetermined time period is set to be not more than T1/2.

According to this configuration, an analog value is converted to a digital value of the predetermined bit number by the analog-digital converter. The first detection voltage is converted to the digital value by the analog-digital converter, the first detection voltage increased by the first voltage which is applied to the first wire from the voltage applying portion. The time period, from the time when the voltage applying portion starts to apply the first voltage to the time when the digital value remains unchanged even though the first detection voltage increases, is defined as T1 . The predetermined time period is set to be not more than T1/2. Consequently, the first detection voltage is detected by the detector at a time point at which not more than half of a time period has elapsed, the time period being an elapsed time until increase of the first detection voltage is substantially saturated. As a result, the processor may start the predetermined processing in response to the first detection voltage at a time point earlier than a case where the processor waits until the increase of the first detection voltage is substantially saturated.

The touch panel device may further comprise an analog-digital converter which converts an analog value to a digital value of a predetermined bit number, wherein the analog-digital converter converts the second detection voltage to the digital value, the second detection voltage increased by the second voltage which is applied to the second wire from the voltage applying portion, a time period, from the time when the voltage applying portion starts to apply the second voltage to the time when the digital value remains unchanged even though the second detection voltage increases, is defined as T2, and the predetermined time period is set to be not more than T2/2.

According to this configuration, an analog value is converted to a digital value of the predetermined bit number by the analog-digital converter. The second detection voltage is converted to the digital value by the analog-digital converter, the second detection voltage increased by the second voltage which is applied to the second wire from the voltage applying portion. The time period, from the time when the voltage applying portion starts to apply the second voltage to the time when the digital value remains unchanged even though the second detection voltage increases, is defined as T2. The predetermined time period is set to be not more than T2/2. Consequently, the second detection voltage is detected by the detector at a time point at which not more than half of a time period has elapsed, the time period being an elapsed time until increase of the second detection voltage is substantially saturated. As a result, the processor may start the predetermined processing in response to the second detection voltage at a time point earlier than a case where the processor waits until the increase of the second detection voltage is substantially saturated.

A control method of the touch panel device, the control method may include the steps of: applying a first voltage to the first wire and a second voltage to the second wire by the voltage applying portion; detecting a voltage generated at the first electrode pair as a first detection voltage and a voltage generated at the second electrode pair as a second detection voltage by the detector; and performing predetermined processing in response to the first and second detection voltages by the processor, wherein the first voltage is set to be higher than the second voltage.

According to this configuration, the first voltage is applied to the first wire by the voltage applying portion. The second voltage is applied to the second wire by the voltage applying portion. The voltage generated at the first electrode pair is detected by the detector as the first detection voltage, and the voltage generated at the second electrode pair is detected by the detector as the second detection voltage. The predetermined processing is performed by the processor in response to the first detection voltage and the second detection voltage.

The first wire is longer than the second wire. Consequently, resistance difference is generated between the first electrode pair and the second electrode pair. Accordingly, in a case of applying the same voltage to the first electrode pair and the second electrode pair, a degree of increase of the voltage generated at the first electrode pair becomes more gradual than a degree of increase of the voltage generated at the second electrode pair. However, in this configuration, the first voltage is set to be higher than the second voltage by the voltage applying portion. Therefore, the voltage generated at the first electrode pair may be made more approximate to the voltage generated at the second electrode pair at an early time point. As a result, a degree of prolongation of a detection time period, produced by resistance difference owing to difference between a length of the first wire and a length of the second wire, may be reduced.

### INDUSTRIAL APPLICABILITY

In a touch panel device of an electrostatic capacity type, the present disclosure is useful as a touch panel device and a control method of the touch panel device which may reduce a degree of prolongation of a detection time period caused by resistance difference owing to difference of wire length.

What is claimed is:

1. A touch panel device comprising:
a first electrode pair and a second electrode pair each of which is provided on a substrate so as to form a capacitor;
a first wire which is connected to one electrode of the first electrode pair;
a second wire which is connected to one electrode of the second electrode pair;
a voltage applying portion which is connected to the first wire to apply a first voltage to the first wire and is connected to the second wire to apply a second voltage to the second wire;
a detector which detects a voltage of the first electrode pair as a first detection voltage and a voltage of the second electrode pair as a second detection voltage, the first detection voltage being generated by applying the first voltage from the voltage applying portion, the second detection voltage being generated by applying the second voltage from the voltage applying portion; and
a processor which performs predetermined processing in response to the first and second detection voltages detected by the detector, wherein
the first wire is configured to be longer than the second wire, and
the voltage applying portion sets the first voltage higher than the second voltage.

2. The touch panel device according to claim 1, wherein
a length of the first wire is defined as L1,
a length of the second wire is defined as L2,
a voltage value of the first voltage is defined as V1,
a voltage value of the second voltage is defined as V2, and
the voltage applying portion applies a voltage of the voltage value V1 to the first wire and a voltage of the voltage value V2 to the second wire, the voltage values V1 and V2 satisfying a relationship where V1/V2 is proportional to L1/L2.

3. The touch panel device according to claim 2, further comprising a storage which stores the voltage values V1 and V2 which satisfy the relationship where V1/V2 is proportional to L1/L2, wherein
the voltage applying portion respectively applies voltages of the voltage values V1 and V2 stored in the storage to the first wire and to the second wire.

4. The touch panel device according to claim 1, wherein the detector detects the first detection voltage in a predetermined time period after the first voltage is applied to the first wire by the voltage applying portion, and detects the second detection voltage in the predetermined time period after the second voltage is applied to the second wire by the voltage applying portion.

5. The touch panel device according to claim 4, further comprising an analog-digital converter which converts an analog value to a digital value of a predetermined bit number, wherein
the analog-digital converter converts the first detection voltage to the digital value, the first detection voltage increased by the first voltage which is applied to the first wire from the voltage applying portion,
a time period, from the time when the voltage applying portion starts to apply the first voltage to the time when the digital value remains unchanged even though the first detection voltage increases, is defined as T1, and
the predetermined time period is set to be not more than T1/2.

6. The touch panel device according to claim 4, further comprising an analog-digital converter which converts an analog value to a digital value of a predetermined bit number, wherein
the analog-digital converter converts the second detection voltage to the digital value, the second detection voltage increased by the second voltage which is applied to the second wire from the voltage applying portion,
a time period, from the time when the voltage applying portion starts to apply the second voltage to the time when the digital value remains unchanged even though the second detection voltage increases, is defined as T2, and
the predetermined time period is set to be not more than T2/2.

7. A control method of the touch panel device according to claim 1, the control method comprising the steps of:
applying a first voltage to the first wire and a second voltage to the second wire by the voltage applying portion;
detecting a voltage generated at the first electrode pair as a first detection voltage and a voltage generated at the second electrode pair as a second detection voltage by the detector; and
performing predetermined processing in response to the first and second detection voltages by the processor, wherein the first voltage is set to be higher than the second voltage.
